(19) United States
(12) Patent Application Publication
(10) Pub. No.: US 2016/0132523 A1
(43) Pub. Date: May 12, 2016

(54) EXPLOITING NODE-LOCAL DEDUPLICATION IN DISTRIBUTED STORAGE SYSTEM

(71) Applicant: Strato Scale Ltd., Herzlia (IL)

(72) Inventor: Avishay Traeger, Modi'in (IL)

(21) Appl. No.: 14/538,848

(22) Filed: Nov. 12, 2014

(51) Int. Cl. G06F 17/30

(52) U.S. Cl. CPC G06F 17/30156; G06F 17/303; G06F 17/30876

(57) ABSTRACT

Data deduplication is carried out in a storage system in which a set of volumes of data is distributed among a plurality of servers. The technique comprises computing a similarity metric among volumes of the set, making a determination that a difference in the similarity metric is less than a predetermined threshold value. Responsively to the determination there is a migration of the data of the volumes of the set within their respective servers to distribute the migrated data in like manner in the respective servers. Thereafter data deduplication is performed on the respective servers.

### BACKGROUND OF THE INVENTION

1. Field of the Invention

This invention relates to data storage systems. More particularly, this invention relates to deduplication in distributed storage systems.

2. Description of the Related Art

Data deduplication refers to the process of eliminating or significantly reducing multiple copies of the same data in a storage system for the purpose of conserving storage space. The effectiveness of data deduplication may be measured as the deduplication ratio, often defined as the ratio of storage capacity without deduplication to storage capacity with deduplication.

Data deduplication is itself resource intensive and there is a tradeoff between effectiveness of a data deduplication algorithm and consumption of resources. The latter factor is particularly debilitating to a distributed storage system, because of the burden imposed by I/O traffic needed to coordinate multiple server nodes.

In a typical distributed storage system, data objects (referred to “volumes”) are distributed or striped across nodes. A volume may be regarded as a virtual disk with which users interact. For example, a user can request a 50 GB volume, and the storage system will provide it.

Within a volume consecutive data segments may be “striped”, i.e., by interleaving or pseudorandomly placing portions of the data on more than one node or physical storage device. There exists a method of routing I/O requests to nodes and disks, which may, for example, rely on calculation and/or tables. Further, the routing may be done at multiple levels—for example, a global routing to determine which node to send to, and a local routing at each node to determine the location in caches and on specific storage devices.

While various implementations for deduplication are known, in one method, the data is split into “chunks”, whose size may or may not be uniform, and which do not necessarily correspond to the data segments used in striping. A “fingerprint”(e.g., hash) is calculated on each chunk to identify its contents more succinctly. Write I/O requests are routed based on their content. Read I/Os are routed according to where the corresponding data exists in the storage system; in one method this is done by having tables map volumes' logical spaces to fingerprints, which in turn map to physical locations.

Today, most deduplication solutions are “global”—they calculate fingerprints on the entirety of the data stored in the system. This is beneficial because it has the potential to remove all duplicated data from the system, yielding optimal deduplication ratios. Global deduplication, however, has two main drawbacks. First, the tables for routing I/O requests according to fingerprints can be very large. Table access needs to be fast, but the contents also need to be resilient to failures. Consequently, in one method, the table is split and stored in the memory of multiple nodes, possibly adding another hop to I/O requests. Second, routing of I/O requests to nodes that store the data is affected by the data deduplication algorithm.

It is possible to apply local data deduplication procedures to each storage node to avoid extra hops. The I/O routing mechanism is oblivious to such data deduplication. But this approach greatly reduces the system-wide deduplication ratio, as it only operates on those data segments that happen to be on the same node.

### SUMMARY OF THE INVENTION

There is provided according to embodiments of the invention a method of data deduplication, which is carried out in a storage system in which a set of volumes of data is distributed among a plurality of servers. The method comprises computing a similarity metric among volumes of the set, making a determination that a difference in the similarity metric is less than a predetermined threshold value. The method is further carried out responsively to the determination by migrating the data of the volumes of the set within their respective servers to distribute the migrated data in like manner in the respective servers, and thereafter performing data deduplication on the respective servers.

In an aspect of the method the volumes of data are distributed among the volumes according to a pseudorandom striping scheme, wherein the volumes of data have respective seeds and wherein migrating the data includes changing the seeds of the volumes to new seeds and redistributing the data of the volumes of the set according to the new seeds.

One aspect of the method includes creating thin-provisioned copies of the volumes by copying local deduplication metadata, wherein the volumes and the copies have a common routing.

According to a further aspect of the method, computing a similarity metric includes determining that I/O requests to the volumes of the set have been made within a time interval that is shorter than a predetermined threshold.

According to still another aspect of the method, computing a similarity metric includes determining that data in I/O requests to the volumes of the set have a difference in a data similarity metric that is less than a predetermined data similarity threshold value.

Yet another aspect of the method includes performing a cost-benefit analysis of deduplicating the volumes of the set, wherein migrating the data is performed responsively to the cost-benefit analysis.

According to an additional aspect of the method, the cost-benefit analysis includes calculating a deduplication ratio resulting from deduplication of the volumes of the set.

There is further provided according to embodiments of the invention a data processing apparatus including a storage system in which a set of volumes of data is distributed among a plurality of servers, wherein at least one of the servers is configured for computing a similarity metric among volumes of the set, making a determination that a difference in the similarity metric is less than a predetermined threshold value, responsively to the determination migrating the data of the volumes of the set within their respective servers to distribute the migrated data in like manner in the respective servers, and thereafter performing data deduplication on the respective servers.

### BRIEF DESCRIPTION OF THE SEVERAL VIEWS OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a schematic illustration of a system having distributed storage operative for data deduplication in accordance with an embodiment of the invention;

FIG. 2 is a block diagram illustrating an arrangement of deduplication pointer tables in accordance with an embodiment of the invention;

FIG. 3 is a block diagram illustrating an arrangement of deduplication pointer tables in accordance with an alternate embodiment of the invention; and

FIG. 4 is a flow chart of a method of data deduplication in accordance with an embodiment of the invention.

### DETAILED DESCRIPTION OF THE INVENTION

In the following description, numerous specific details are set forth in order to provide a thorough understanding of the various principles of the present invention. It will be apparent to one skilled in the art, however, that not all these details are necessarily always needed for practicing the present invention. In this instance, well-known circuits, control logic, and the details of computer program instructions for conventional algorithms and processes have not been shown in detail in order not to obscure the general concepts unnecessarily.

### DEFINITIONS

A “volume” refers to a logical entity that a user interacts with. A volume may be regarded, for example, as a virtual disk. A volume is composed of smaller units, e.g., “chunks”. The deduplication algorithms described herein typically operate on chunks.

As used herein local deduplication or local data deduplication refers to a deduplication process applied to units or volumes of data, which are colocated on one server or storage unit.

Global deduplication applies to a deduplication process that may involve any number of servers or storage units in a distributed data storage system.

### System Overview.

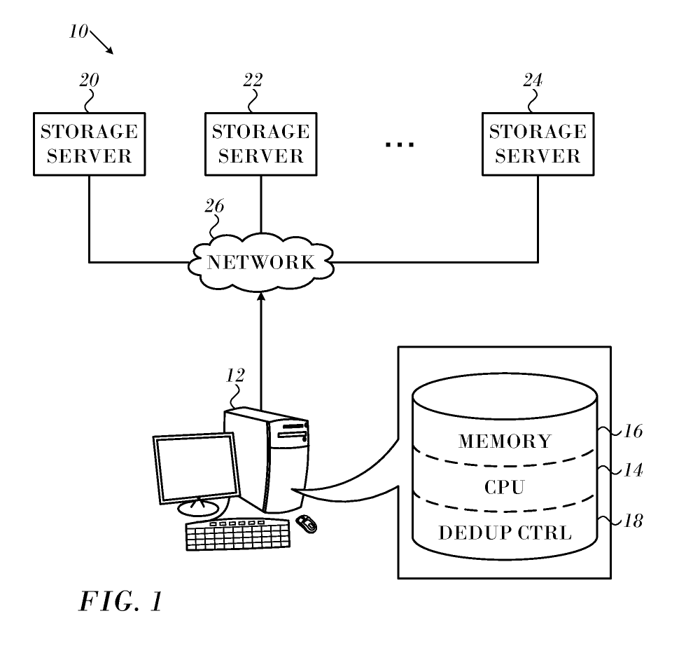

Turning now to the drawings, reference is initially made to FIG. 1, which is a schematic illustration of a system 10 having distributed storage that is suitable for carrying out the invention. The system 10 typically comprises a general purpose or embedded computer processor 12, which is programmed with suitable software for carrying out the functions described hereinbelow. Thus, although the system 10 is shown as comprising a number of separate functional blocks, these blocks are not necessarily separate physical entities, but rather represent different computing tasks or data objects stored in a memory that is accessible to the processor. These tasks may be carried out in software running on a single processor, or on multiple processors. The software may be embodied on any of a variety of known non-transitory media for use with a computer system, such as a diskette, or hard drive, or CD-ROM. The code may be distributed on such media, or may be distributed to the system 10 from the memory or storage of another computer system (not shown) over a network. Alternatively or additionally, the system 10 may comprise a digital signal processor or hard-wired logic. The system 10 may have other configurations than shown in FIG. 1. For example, the processor 12 may be incorporated in a client or located in a server having administrative functions.

The processor 12 comprises at least one central processing unit 14 (CPU) and a memory 16. Among the programs executed by the processor 12 is a deduplication control module 18, which may be implemented in software and reside in the memory 16 or may be implemented in hardware. The functions of the deduplication control module 18 may include establishing or modifying parameters of a deduplication algorithm, described in further detail below, scheduling deduplication activities, and setting priorities. The functionality of the deduplication control module 18 need not be physically located in processor 12 as shown, but may be located in a storage server or even distributed among multiple servers and processors.

Data storage in the system 10 is distributed among the memory 16 and any number of storage servers, represented in the example of FIG. 1 as storage servers 20, 22, 24. The processor 12 and the storage servers 20, 22, 24 are linked via a data network 26. While in the example of FIG. 1 the servers are shown as separate physical nodes, this is not necessarily the case. Client and server processes may execute on the same physical nodes.

### Deduplication.

The deduplication control module 18 may implement the deduplication algorithms to be run on the storage servers by transmission of suitable data access requests across the network 26. Alternatively, programs for executing the deduplication algorithms may be implemented in each of the storage servers 20, 22, 24. As noted above, there are many possible configurations for locating the deduplication logic and processes executed by the deduplication control module 18. The processes may be distributed among the servers and clients of the system 10. For example, a client process sends a write request to a first server, which calculates the fingerprint, and forwards the result to a second server based on the output. Alternatively, the client sends a read request for some logical address to the first server, which then redirects it to the second server based on table lookup(s). The client may also have this logic, where it does the required computation and lookups itself.

In order to perform data deduplication, a system needs to be able to identify redundant copies of the same data. Because of the processing requirements involved in comparing each incoming unit of data with each unit of data that is already stored in the system, the detection is usually performed by comparing smaller data fingerprints of each data unit instead of comparing the data units themselves. This generally involves calculating a new fingerprint (e.g., a hash or checksum) for each unit of data to be stored on the deduplication system and then comparing that new fingerprint to the existing fingerprints of data units already stored by the deduplication system. Identity between the two indicates that a copy of the data is stored in the system. It is recognized that collisions can occur, but they are outside the scope of this disclosure.

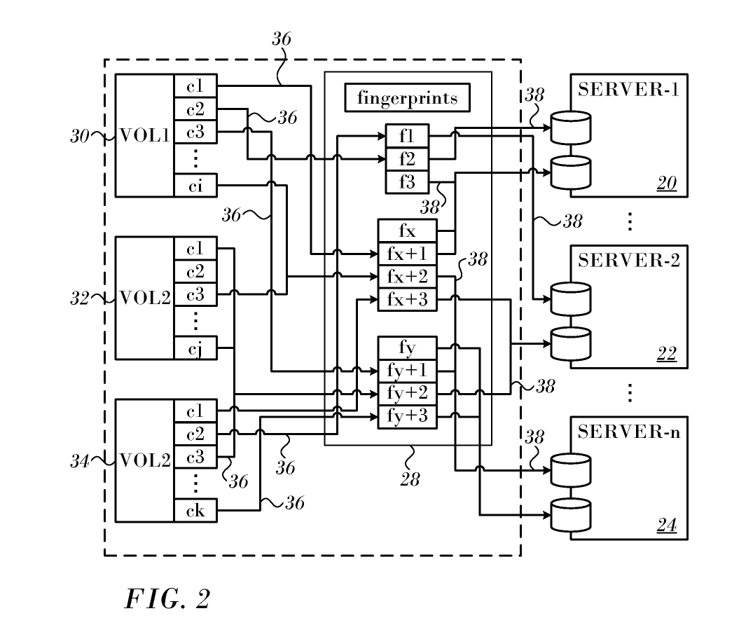

Reference is now made to FIG. 2, which is a block diagram illustrating an arrangement of deduplication pointer tables in the deduplication control module 18 and the servers 20, 22, 24 (FIG. 1), in accordance with an embodiment of the invention. Deduplication pointer tables 28 comprise fingerprints of the stored data that reference locations on the servers 20, 22, 24 where the data is actually stored and can be accessed in chunks from logical volumes 30, 32, 34 using the deduplication pointer tables 28 as shown by series of arrows 36, 38. FIG. 2 contemplates many different methods of fingerprint compilation. For example, the deduplication pointer tables may comprise a multilevel system of tables. FIG. 2 assumes that deduplication happens on the data path—as a write operation comes in, the fingerprint is calculated, checked against the table, and so on.

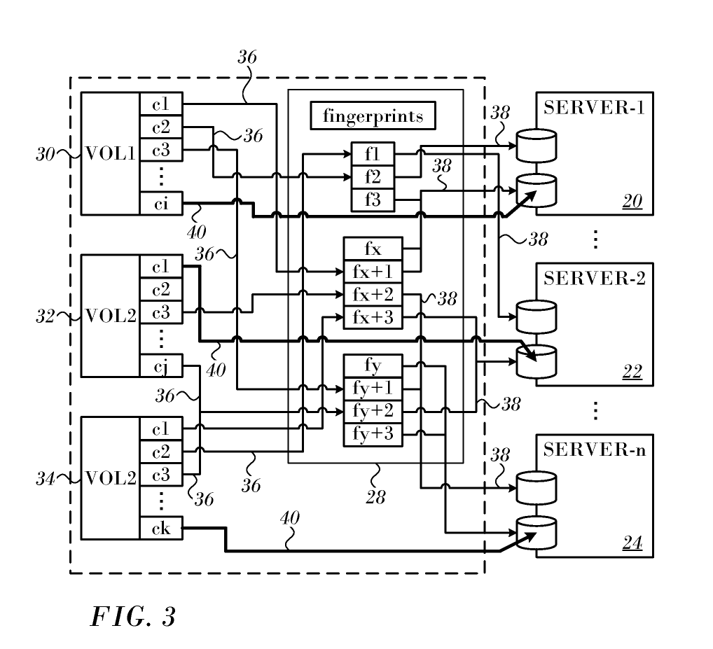

Reference is now made to FIG. 3, which is a block diagram similar to FIG. 2 illustrating an arrangement of deduplication pointer tables in the deduplication control module 18 and the servers 20, 22, 24 (FIG. 1), in accordance with an alternate embodiment of the invention. Some of the pointers from the volumes point straight to locations on the physical storage, as indicated by arrows 40. These references indicate recent write operations. A background process calculates checksums and then performs required deduplication so as to update the pointers indicated by arrows 40 to conform to those in FIG. 2.

Deduplication operations using the arrangements shown in FIG. 2 and FIG. 3 can be performed on-the-fly or offline as shown in more detail by the following flow-chart.

### Operation.

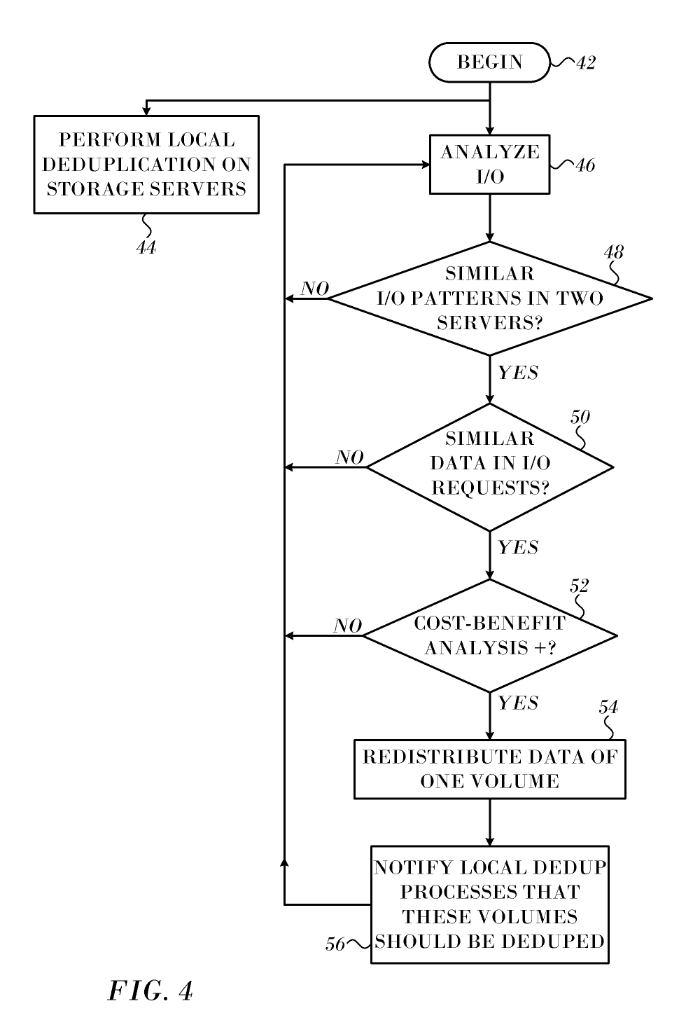

Reference is now made to FIG. 4, which is a flow-chart of a method of data deduplication, in accordance with an embodiment of the invention. The process steps are shown in a particular linear sequence in FIG. 4 for clarity of presentation. However, it will be evident that many of them can be performed in parallel, asynchronously, or in different orders. Those skilled in the art will also appreciate that a process could alternatively be represented as a number of interrelated states or events, e.g., in a state diagram. Moreover, not all illustrated process steps may be required to implement the method. The method may be implemented efficiently, provided that global routing to volumes being evaluated is the same.

At initial step 42, any desired preliminary conditions are satisfied. For example, deduplication may be scheduled as a convenient maintenance task. Initial step 42 contemplates arrival of the time to perform such tasks. In another example, in initial step 42 a check may be made to determine that the relevant storage servers are all on-line.

Next, at step 44 local data deduplication is performed independently on each relevant server or storage device. While local data deduplication may be performed exhaustively, it is more efficient to test volumes on the local server for similarity, as described below. Volumes on the same server found to be similar may be subjected to deduplication. Each storage device operates only on data stored in that device, typically using its own deduplication pointer tables. Step 44 may be performed either as a background process or inline in response to new write requests. This step is conventional and is not described further herein, as many suitable variants are known in the art. As noted above, step 44 does not affect global routing efficiency.

Step 46 comprises a monitor of I/O requests that are directed to the storage servers in the system. Similar I/O patterns, e.g., concurrent I/O activity, directed to two (or more) volumes are an indicator that the servers may contain similar data. If concurrent I/O activity is directed to N volumes, they can be treated in pairs so that all N volumes are ultimately deduplicated. For example, if volumes A, B and C are being evaluated, it can first be determined that volumes A and B have similar I/O patterns, and then that volume C is similar to volumes A and/or B.

As noted above step 46 and the subsequent steps shown herein need not be performed in the order presented in the example of FIG. 4. The monitor may comprise subcombinations of the analysis steps described below. Indeed, not all the steps may be performed in particular implementations. Moreover, the examples of similarity metrics for I/O requests cited herein are presented by way of example and not of limitation. Many other metrics of similarity will occur to those skilled in the art. At decision step 48 it is determined if similar I/O patterns exist, e.g., I/O requests that have been sent to two volumes at about the same time, e.g., within a predetermined time interval that indicates concurrency of the two I/O requests. If the determination at decision step 48 is negative, then monitoring continues at step 46. Evaluation of similarity of the I/O requests may consider the following information in the requests: 1). read or write; and 2) the logical offset in the volume. For example, similarity in the I/O pattern is indicated if writes to five consecutive blocks in both volumes occur at about the same time. In another example, random access around the first 1000 blocks of both volumes may be treated as similar I/O patterns.

If the determination at decision step 48 is affirmative, then a further evaluation of the targets of the I/O requests is made at decision step 50. It is determined if the I/O requests directed to the targets have similar data. Volumes are similar if a similarity metric describing each of their data fingerprints does not differ by more than a predetermined threshold value. A number of suitable data fingerprinting similarity measures based on entropy estimates, hashing schemes and Bloom filters are known, for example, from the document Data Fingerprinting With Similarity Digests, Vasil Roussev, Advances In Digital Forensics VI, Chap 8, IFIP Advances in Information and Communication Technology, Vol. 337, 2010. The similarity analysis may be one of the analyses described in the Roussev document. At decision step 48 it is determined whether the two servers have volumes chunks with the same or nearly the same data characteristics, i.e., the volumes are similar. Additionally or alternatively, similarity metrics can be derived from any of the following schemes or combinations thereof:

1. Split the data being written to the two volumes into chunks and calculate fingerprints, and see how many fingerprints from the first volume match those from the second.

2. Calculate the entropy of each stream, or split the stream into parts and calculate the entropy on each, and compare those numbers.

3. Look at the “alphabet” of each stream—split each stream into bytes, and record the values. The values make up the alphabet for each stream. If there is a large overlap, parts of the streams may be identical.

The above similarity metrics are exemplary. Any known method of similarity may be employed in decision step 50.

If the determination at decision step 50 is affirmative then control proceeds to decision step 52. It is determined in decision step 52 whether the expected savings of deduplicating the two similar volumes justifies the costs to migrate one of the volumes so that its data is distributed like the other volume's data. Data migration is expensive in terms of computer resources. A cost-benefit analysis is performed using known methods, e.g., taking into consideration service-level agreements for the affected volumes and the system as a whole. For example, the cost-benefit analysis may comprise a comparison of some or all of the data of the two volumes and calculating the deduplication ratio, i.e., how much storage would be saved by performing deduplication. Also to be considered is the benefit on long-term performance, e.g., as measured by performance metrics and compliance with the service level agreements. The initial cost of deduplication should also be taken into account. For example, the larger the volume, the more resources are required to move the data. Factors such as the speed of the disks and the bandwidth of the network also affect the cost. Of course the transfer could be done opportunistically when the system is not under heavy load so as not to disturb active workloads,

If the determination at decision step 52 is affirmative then control proceeds to step 54 where data is redistributed on one of the volumes. In the case of pseudorandom distribution there is typically a seed for randomization in each volume, and restriping may involve changing the seeds. However, restriping may be performed using many known restriping methods, so that any offset A in the first volume is on the same server as the offset A in the second volume, in order that they can be deduplicated effectively. For example, the method described in U.S. Patent Application Publication No. 2006/0248273, can be used by the local deduplication processes. The result is to relocate the migrated volume to a set of receiving servers, such that the two volumes are distributed in the same way—segments of the first volume reside on the same server as corresponding segments of the second volume. Routing information for the migrated volume must be updated as well, so that I/O requests are serviced according to the new locations of the data.

Then in step 56 local deduplication processes are invoked and informed that deduplication of the volumes should be performed. Once step 56 has been accomplished or if the determination at any of decision steps 48, 50, 52 is negative, control returns to step 46 to iterate the procedure.

### Alternate Embodiment

In one implementation thin-provisioned snapshots of volumes are created, in which each node or server creates a copy of the deduplication pointer tables of the volumes being evaluated. With thin provisioning, the fact that one volume is a clone of another indicates that the chunks that comprise them are necessarily the same at the time of the cloning operation, although the contents of either volume may change afterward. In this embodiment deduplication metadata is copied rather than the data itself, and the copies and the original have common routing.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method of data deduplication comprising the steps of:
in a storage system comprising a plurality of servers having a set of volumes of data distributed therein, computing a similarity metric among volumes of the set;
making a determination that a difference in the similarity metric is less than a predetermined threshold value;
responsively to the determination migrating the data of the volumes of the set within their respective servers to distribute the migrated data in like manner in the respective servers; and
thereafter performing data deduplication on the respective servers.

2. The method according to claim 1, wherein the volumes of data are distributed among the volumes according to a pseudorandom striping scheme, wherein the volumes of data have respective seeds, wherein migrating the data comprises the steps of:
changing the seeds of the volumes of the set to new seeds; and
redistributing the data of the volumes of the set according to the new seeds.

3. The method according to claim 2, further comprising creating thin-provisioned copies of the volumes by copying local deduplication metadata, wherein the volumes and the copies have a common routing.

4. The method according to claim 1, wherein computing a similarity metric comprises determining that I/O requests to the volumes of the set have been made within a time interval that is shorter than a predetermined threshold.

5. The method according to claim 1, wherein computing a similarity metric comprises determining that data in I/O requests to the volumes of the set have a difference in a data similarity metric that is less than a predetermined data similarity threshold value.

6. The method according to claim 1, further comprising performing a cost-benefit analysis of deduplicating the volumes of the set, wherein the step of migrating the data is performed responsively to the cost-benefit analysis.

7. The method according to claim 6, wherein the cost-benefit analysis comprises calculating a deduplication ratio resulting from deduplication of the volumes of the set.

8. A data processing apparatus comprising:
a storage system comprising a plurality of servers having a set of volumes of data distributed therein, wherein at least one of the servers is configured for performing the steps of:
computing a similarity metric among volumes of the set;
making a determination that a difference in the similarity metric is less than a predetermined threshold value;
responsively to the determination migrating the data of the volumes of the set within their respective servers to distribute the migrated data in like manner in the respective servers; and
thereafter performing data deduplication on the respective servers.

9. The apparatus according to claim 8, wherein the volumes of data are distributed among the volumes according to a pseudorandom striping scheme, wherein the volumes of data have respective seeds, wherein migrating the data comprises the steps of:
changing the seeds of the volumes of the set to new seeds; and
redistributing the data of the volumes of the set according to the new seeds.

10. The apparatus according to claim 8, wherein the at least one of the servers is operative for creating thin-provisioned copies of the volumes by copying local deduplication metadata, wherein the volumes and the copies have a common routing.

11. The apparatus according to claim 8, wherein computing a similarity metric comprises determining that I/O requests to the volumes of the set have been made within a time interval that is shorter than a predetermined threshold.

12. The apparatus according to claim 8, wherein computing a similarity metric comprises determining that data in I/O requests to the volumes of the set have a difference in a data similarity metric that is less than a predetermined data similarity threshold value.

13. The apparatus according to claim 8, further comprising performing a cost-benefit analysis of deduplicating the volumes of the set, wherein the step of migrating the data is performed responsively to the cost-benefit analysis.

14. The apparatus according to claim 13, wherein the cost-benefit analysis comprises calculating a deduplication ratio resulting from deduplication of the volumes of the set.
